(19) United States
(12) Patent Application Publication
(10) Pub. No.: US 2013/0087238 A1
(43) Pub. Date: Apr. 11, 2013

(54) DOUBLE-WALLED FLUID TRANSPORT PIPE, INSTALLATION OF SUCH A PIPE, AND AIRCRAFT COMPRISING SUCH A PIPE

(71) Applicant: DASSAULT AVIATION, Paris (FR)

(72) Inventor: Paul-Andre MERCIER, Le Pian-Medoc (FR)

(73) Assignee: DASSAULT AVIATION, Paris (FR)

(21) Appl. No.: 13/645,991

(22) Filed: Oct. 5, 2012

(30) Foreign Application Priority Data
Oct. 7, 2011 (FR) 11 03065

(51) Int. Cl. F16L 11/00; B23Q 17/00

(52) U.S. Cl. 138/118.1; 29/407.1

(57) ABSTRACT

The pipe (1) according to the invention includes:
a fluid circulation hose (3),
an outer protective tube (5), arranged around said hose (3) coaxially to said hose (3), and
means (9) for centering said hose (3) in the outer protective tube (5).

Said outer protective tube (5) comprises:
at least one shell (21) in the form of a hollow tube having a transverse section larger than the transverse section of said hose (3), and forming an annular space (7) between said hollow tube and said hose (3) to receive said centering means (9), and
an enclosure (23) that is wound on the outer surface of said shell (21), the enclosure (23) sealably surrounding the annular space (7).

The present invention relates to a fluid transport pipe, of the type comprising:
a fluid circulation hose,
an outer protective tube, arranged around said hose coaxially to said hose, and
means for centering said hose in the outer protective tube.

It in particular applies to the pressurization of the fuel tank in an aircraft. Pressurizing the fuel tank makes it possible to guarantee the fuel supply for the engines from the tank even in the event of a breakdown of the fuel pumps.

The fuel tank is pressurized using the pressurization circuit, which is in communication with the engine outlets of the aircraft to generate the overpressure and which makes it possible to ensure a controlled overpressure at the fuel tank.

This pressurization circuit is configured so as to have one or more “loops” (circuit portions in the shape of an upside down U) arranged inside the fuselage (for example around a window) and which are raised in relation to the tank.

In fact, without these loops, the fuel contained in the tanks localized at the wings of the aircraft may risk flowing into unwanted areas of the pressurization circuit in the event of a significant deflection of those wings.

This part of the pressurization circuit being located in the area of the aircraft cabin, it is also necessary to provide that in the event of a fuel leak, that fuel flows outside the aircraft.

To avoid such leaks, it is thus known to use double-walled hoses within the fuselage, comprising an internal fluid circulation hose, connecting the inside of the tank to the pressurization circuit, and an outer hose surrounding the inner hose at least in the fuselage. A fuel circulation passage is provided between the inner hose and the outer hose, so as to allow drainage of any fuel leak toward the outside of the fuselage.

The outer hose is for example made using two semi-cylindrical half-shells, assembled around the inner hose. These half-shells are fastened to one another by riveting their pinned edges, and are also fastened on the fuselage.

Such a solution has several drawbacks.

In particular, the rejection rate during the manufacture of these double-walled pipes is high, any sizing error being able to create a leak at the riveted bond lines.

Furthermore, the installation of the half-shells is often delicate. In particular, the position of these half-shells cannot be adjusted heightwise, such that it is necessary to adapt the fastening holders of the half-shells to the frames of the fuselage and sometimes even to file off those frames, which leads to the establishment of a noncompliance or derogation report. Furthermore, the reduced play between the riveted edges and the frames of the fuselage prevents an effective installation of the soundproofing pads of the fuselage.

To produce these double-walled pipes, it is also known to form a double tube comprising two coaxial hoses and to insert a permeable mat between those two hoses allowing fluid to circulate between the two hoses. However, this mat is a developable surface and therefore does not make it possible to produce pipes with a high degree of curvature, which are necessary when the available space is small.

The invention therefore aims to offset these drawbacks, and in particular to propose a double-walled pipe with minimized manufacturing and installation constraints.

To that end, the invention relates to a pipe of the aforementioned type, characterized in that said outer protective tube comprises:
at least one shell in the form of a hollow tube having a transverse section larger than the transverse section of said hose, and forming an annular space between said hollow tube and said hose to receive said centering means, and
an enclosure that is wound on the outer surface of said shell, the enclosure sealably surrounding the annular space.

According to other aspects of the invention, the pipe comprises one or more of the following features:
said centering means comprise a tubular centering device adapted to be inserted into said annular space between an inner surface of said shell and an outer surface of said hose;
said centering device is in the form of a cylinder portion, and comprises an inner surface adapted to bear against the outer surface of said hose;
said centering device comprises at least two longitudinal ribs protruding radially from an outer surface of said centering device and comprising a surface capable of bearing against the inner surface of said outer tube;
said ribs define at least two longitudinal channels for the circulation of a fluid;
said centering device is made from a deformable material, and comprises a longitudinal opening over its entire length able to allow the installation of said centering device by clipping around said hose;
said shell comprises at least two shells of complementary shape, assembled to form said shell;
each shell includes a straight longitudinal edge and a bearing longitudinal edge, the bearing edge of each shell receiving the straight edge of the other shell by surface bearing;
the pipe also comprises at least one base connected to at least one longitudinal end of said outer tube, said base comprising a cylindrical longitudinal wall comprising an inner surface with a shape conjugated to the outer surface of a longitudinal end of said shell, defining an outlet opening for a fluid, and a transverse fastening wall protruding radially toward the outside from said longitudinal wall;
said enclosure is made from impregnated composite fabric.

The invention also relates to an aircraft comprising a fuselage defining an inner space, characterized in that it comprises a pipe as defined above, at least partially arranged inside said fuselage, the annular space of said pipe being fluidly connected to the outside of said fuselage.

The invention also relates to a method for installing a fluid transport pipe as described above, comprising:
supplying said fluid circulation hose,
installing said centering means around said hose; and
installing said outer protective tube around said centering means, characterized in that the step for installing said outer protective tube around said centering means comprises a step for installing said shell around said hose and a step for winding said enclosure over the outer surface of said shell.

The invention will be better understood using the following description, provided solely as an example and done in reference to the appended drawings, in which:

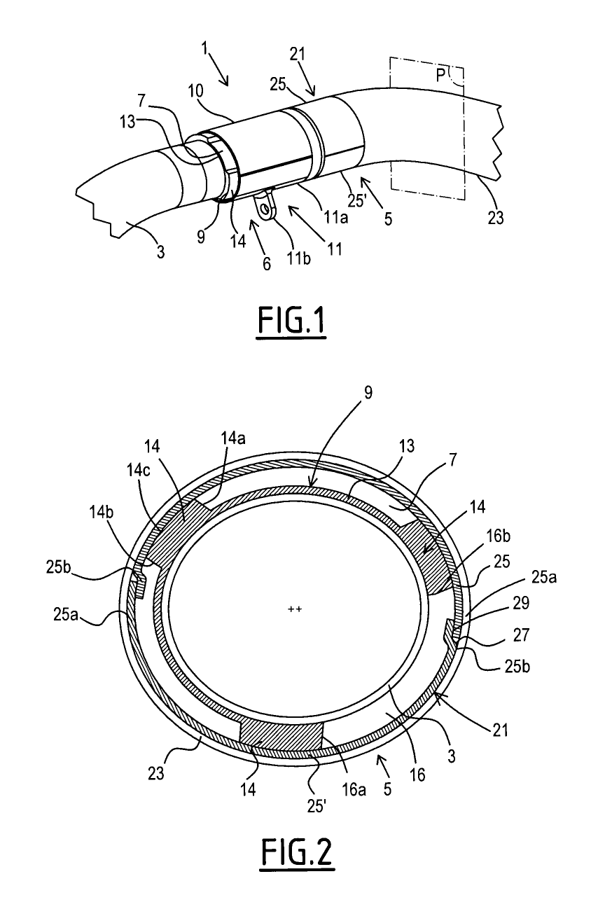

FIG. 1 is a perspective view of a first portion of a pipe according to one embodiment of the invention, wherein part of the outer protective tube has been removed;

FIG. 2 is a cross-sectional view of the pipe of FIG. 1 in the transverse plane P of FIG. 1;

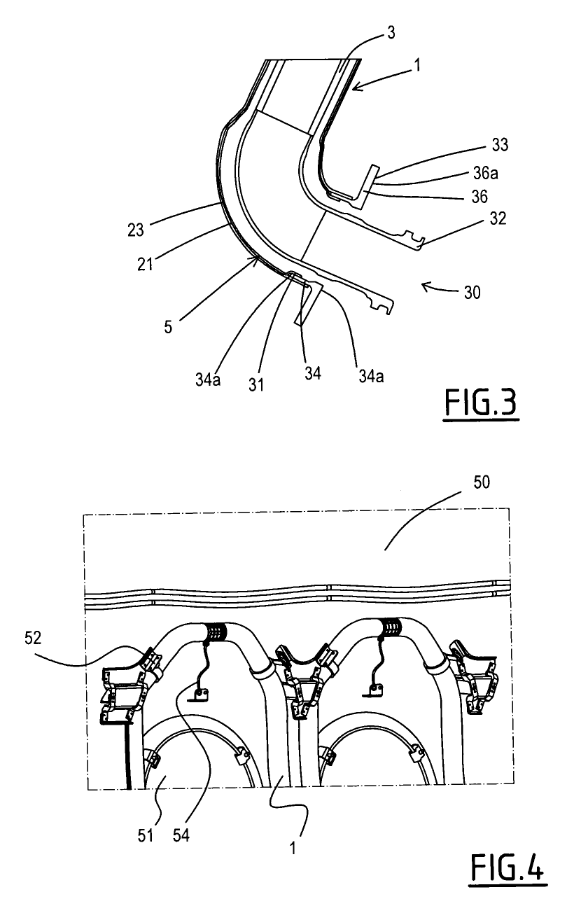

FIG. 3 is a cross-sectional view in a longitudinal plane of the pipe of FIG. 1 at a connection of said pipe on the one hand with the fuselage and on the other hand with the pressurization circuit; and

FIG. 4 is a perspective diagram of the inside of the fuselage of an aircraft comprising a pipe according to the invention.

FIG. 1 shows a pipe 1 according to a first embodiment of the invention, designed to pressurize a tank of the aircraft.

The pipe 1 thus comprises a central portion designed to be arranged inside the fuselage of an aircraft, and two ends respectively connected to a tank of the aircraft and a pressurization circuit capable of creating a controlled overpressure in the fuel tank by means of said pipe. The pressurization circuit is for example in communication with the engine outlets of the aircraft, as specified above.

The pipe 1 comprises a fluid circulation hose 3, an outer protective tube 5, means for centering the hose 3 in the outer tube 5, and means 6 for grounding the hose 3.

In this FIG. 1, only part of the outer tube 5 and the centering means has been shown.

The hose 3 is a hollow tube with a circular transverse section. The hose 3 fluidly connects the fuel tank to the pressurization circuit, for example in an area comprised between the fuselage and the fairing of the aircraft.

The hose 3 is advantageously made from a pressure-resistant metal material, for example T40 titanium.

The outer protective tube 5 is a hollow tube arranged around the hose 3, coaxially to said hose, at least over the portion of the hose situated in the fuselage.

The outer tube 5 thus comprises a central portion designed to be comprised inside the fuselage of an aircraft and two ends designed to be connected to the fuselage.

The outer tube 5 has an inner diameter larger than the outer diameter of the hose 3, so as to form an annular space 7 between the hose 3 and the outer tube 5. This annular space 7 is designed to allow the circulation of fluid between the hose 3 and the outer tube 5, toward the outside of the fuselage, in the event of a break or leak in the hose 3.

The centering means comprise at least one centering device 9, with a generally tubular shape. The centering device 9 is inserted between the hose 3 and the outer tube 5, coaxially to the hose 3.

In particular, the centering device 9 bears against the outer surface of the hose 3 and against the inner surface of the outer tube 5, so as to center the hose 3 in the outer tube 5, and to prevent any contact between the hose 3 and the outer tube 5.

The means 6 for grounding the hose 3 comprise a metal foil 10, surrounding a portion of the centering device 9, and means 11 for connecting the foil 10 to the ground. These means 11 comprise a metal half-cylinder 11a, in surface bearing against the metal foil 10, and a bonding tab 11b, grounded using an electric cable.

As shown in FIG. 2, the centering device 9 comprises a hollow tubular element 13, with a substantially circular transverse section, arranged around the hose 3 coaxial to that hose.

The centering device 9 also comprises a plurality of longitudinal ribs 14 regularly distributed over the outer surface of the tubular element 13. The ribs 14 protrude radially from the outer surface of the tubular element 13, over the entire length of the tubular element 13.

In the illustrated example, there are three ribs 14.

They thus comprise two side surfaces 14a, 14b that are substantially orthogonal to the outer surface of the tubular element 13, and an outer bearing surface 14c, substantially parallel to the outer surface of the tubular element 13. The outer surface 14c is in surface bearing against the inner surface of the outer tube 5.

The ribs 14 define three longitudinal channels between them for the circulation of a fluid, allowing fluid to circulate between the hose 3 and the outer tube 5.

The entire length of the centering device 9 is provided with a longitudinal opening 16, defined between two longitudinal rims 16a, 16b. The opening 16 extends over an angular sector comprised between 60 and 110°, for example equal to 100°.

Furthermore, the centering device is made from a sufficiently elastic and deformable material, for example polycarbonate.

The opening 16 may thus be widened so as to form a passage at least equal to the outer diameter of the hose 3, so as to install the centering device 9 around the hose 3, by clipping.

The centering device 9 advantageously extends over a straight portion of the hose 3. Advantageously, the pipe 1 comprises several centering devices 9 placed between the hose 3 and the outer tube 5 over the straight portions of the hose 3.

The outer tube 5 comprises a shell 21 and an enclosure 23 that is wound over the outer surface of the shell 21.

The shell 21 is arranged around the hose 3 and in particular on the centering device 9, over the entire length of the central portion of the hose 3, with the exception of the portion covered with the metal foil.

The shell 21 comprises two complementary half-shells 25, 25′, which are substantially identical. The transverse section of the half-shells 25, 25′ is substantially semicircular. Each half-shell 25, 25′ thus comprises two longitudinal edges 25a, 25b, and in particular a straight edge 25a and a bearing edge 25b.

Each half-shell 25, 25′ comprises, in the vicinity of its bearing edge 25b, a shoulder 27 oriented toward the inside of the half-shell 25, 25′. The shoulder 27 is extended by a longitudinal bearing border 29, the outer surface of which receives the inner surface of the straight edge 25a of the other half-shell 25′, 25 in surface bearing.

The bearing edge 25b of each half-shell 25, 25′ thus receives the straight edge 25a of the other half-shell 25′, 25 in surface bearing, allowing sealed assembly of said half-shells to form the shell 21.

The half-shells 25, 25′ are for example made from thermoformed polycarbonate.

The enclosure 23 has a tubular shape. It is made up of a sealed material that is wound over the outer surface of the shell 21, advantageously forming several superimposed layers. The enclosure 23 therefore surrounds the shell 21 as close as possible thereto. It thus sealably surrounds the annular space 7, and prevents any fluid leak toward the outside of the pipe 1, to the inside of the fuselage.

The enclosure 23 is advantageously made from a winding of impregnated composite fabric strips, for example strips with a width smaller than their length, for example 50 mm wide, in particular wound in a spiral around the shell.

The composite fabric for example comprises carbon or glass fibers associated with a matrix, for example resin, such as a S.3798 resin by the manufacturer CIBA.

The hose 3 fluidly connects the tank of the aircraft to the pressurization circuit, while the outer tube 5 extends around the hose 3 in the fuselage, between two ends sealably connected to the fuselage.

FIG. 3 thus shows a connecting end 30 for connecting the pipe 1 to the pressurization circuit, also designed to be fastened to the fuselage of an aircraft.

This connecting end 30 is bent. At that end, the pipe 1 therefore does not have a centering device. Furthermore, the longitudinal end of the shell 21 comprises a rim 31 with a reduced diameter, forming a shoulder for fastening connecting means.

At that end 30, the hose 3 comprises a bent connector 32 protruding outside the outer tube 5. Thus, the hose 3 can be inserted through an opening formed in the fuselage of the aircraft, while the outer tube 5 remains inside the fuselage. Advantageously, this opening has a section larger than the section of the hose 3, but smaller than the section of the tube 5.

The pipe 1 also comprises connecting means at that end 30, making it possible to fasten the outer tube 5 sealably to the fuselage.

These connecting means comprise a base 33. The base 33 comprises a substantially cylindrical longitudinal wall 34, coaxial to the outer tube 5. The longitudinal wall 34 is defined between a circular outer rim 34a, oriented toward the end 30, and a circular inner rim 34b.

The longitudinal wall 34 comprises an inner surface with a shape conjugated to the outer surface of the rim 31. Thus, the inner surface of the longitudinal wall 34 is in surface bearing against the rim 31, and its outer surface is covered by the enclosure 23.

The base 33 also comprises a transverse fastening wall 36, orthogonal to the tube 5, forming a flange. The transverse wall 36 has an annular shape. It protrudes radially from the outer rim 34a of the longitudinal wall 34 toward the outside of the tube 5.

The transverse wall 36 comprises an outer surface 36a, oriented toward the outlet of the bent connector 32. The outer surface 36a can engage in surface bearing against an inner surface of the fuselage of the aircraft.

The transverse wall 36 is thus designed to be fastened to the fuselage of the aircraft, inside said fuselage.

The base 33 therefore makes it possible to connect the tube 5 to the fuselage sealably, i.e. preventing any circulation of fluid from the annular space 7 and the fuselage. In the event of a leak in the hose 3, the fluid escaping from the hose flows into the annular space 7 as far as the base 33, and through the opening formed in the fuselage, outside the fuselage of the aircraft.

The second connecting end of the pipe 1, designed to be connected to a fuel tank, is substantially identical to the end described in reference to FIG. 3. The end of the hose 3 protruding outside the protective tube 5, toward the outside of the fuselage, is then designed to be connected to another hose, connected to the tank.

The installation of the pipe 1 first comprises clipping at least one centering device 9 around the central portion of the hose 3.

A base 33 is positioned at each end of the hose 3, around said hose.

The two half-shells 25, 25′ are then positioned around the hose 3, above the centering device 9, to form the shell 21 that completely surrounds the central portion of the hose 3. These half-shells 25, 25′ are for example temporarily kept in position using adhesive strips, before positioning of the enclosure 23.

The bases 33 are also placed at the ends of the shell 21, the inner surface of their longitudinal wall 34 being in surface bearing against the rim 31.

The enclosure 23 is then wound around the entire shell 21, and in particular above the longitudinal wall 34 of the bases 33, so as to fasten said bases 33 to the outer tube 5 sealably.

The composite fabric making up the enclosure 23 is then dried and hardened, for example in a drying apparatus, and finishing layers, for example paint and varnish, are applied on the enclosure 23.

The pipe 1 is then installed in an aircraft, in said fuselage 50, as shown in FIG. 4. The pipe is for example installed around windows 51, along the fuselage 50.

Furthermore, the two ends of the hose 3 are inserted into openings formed in the fuselage 50, and the bases 33 are sealably fastened to that fuselage.

Additionally, the pipe 1 is fastened to the fuselage 50 by lined clamps 52, and the bonding tabs 11 b are connected to the electric ground using electric cables 54.

It will be understood from the preceding description how the pipe according to the invention makes it possible to provide effective protection for a fluid circulation hose without causing significant installation constraints.

In particular, the half-shells are assembled without forming a bond line, which makes it possible to eliminate contact between the pipe and the frames of the fuselage.

Furthermore, due to the absence of this bond line able to create leaks, the rejection rate during manufacture is much lower.

Furthermore, the fastening of the pipe to the frame is made easier, soundproofing is improved, and the risks of vibration and noise in the piping are decreased.

It should, however, be understood that the examples of embodiments presented above are not limiting.

In particular, the shell 21 does not necessarily comprises two half-shells. According to one alternative embodiment, the shell 21 comprises a tubular shell provided with a longitudinal slit and made from a flexible material. The shell is then placed around the hose by clipping.

The shell 21 may also be made from at least three shells with complementary shapes, which are assembled to form a shell having a circular transverse section.

Furthermore, the centering device does not necessarily comprise three ribs. According to another embodiment, the centering device 9 comprises only two diametrically opposite ribs. The centering device 9 may alternatively comprise more than three ribs, for example regularly distributed around the centering device.

Other embodiments may of course be considered.

1. A fluid transport pipe, of the type comprising:
a fluid circulation hose,
an outer protective tube, arranged around said hose coaxially to said hose and
means (9) for centering said hose in the outer protective tube, wherein said outer protective tube comprises:
at least one shell in the form of a hollow tube having a transverse section larger than the transverse section of said hose, and forming an annular space between said hollow tube and said hose to receive said centering means, and
an enclosure that is wound on the outer surface of said shell, the enclosure sealably surrounding the annular space.

2. The pipe according to claim 1, wherein said centering means comprise a tubular centering device adapted to be inserted into said annular space between an inner surface of said shell and an outer surface of said hose.

3. The pipe according to claim 2, wherein said centering device is in the form of a cylinder portion, and comprises an inner surface adapted to bear against the outer surface of said hose (3).

4. The pipe according to claim 3, wherein said centering device comprises at least two longitudinal ribs protruding radially from an outer surface of said centering device and comprising a surface capable of bearing against the inner surface of said outer tube.

5. The pipe according to claim 4, characterized in that said ribs define at least two longitudinal channels for the circulation of a fluid.

6. The pipe according to any one of claims 2 to 5, wherein said centering device is made from a deformable material, and comprises a longitudinal opening (16) over its entire length able to allow the installation of said centering device (9) by clipping around said hose.

7. The pipe according to any one of the preceding claims, wherein said shell comprises at least two shells of complementary shape, assembled to form said shell (21).

8. The pipe according to claim 7, wherein each shell includes a straight longitudinal edge and a bearing longitudinal edge, the bearing edge of each shell receiving the straight edge of the other shell by surface bearing.

9. The pipe according to any one of the preceding claims, also comprising at least one base connected to at least one longitudinal end of said outer tube, said base comprising a cylindrical longitudinal wall comprising an inner surface with a shape conjugated to the outer surface of a longitudinal end of said shell, and defining an outlet opening for a fluid, and a transverse fastening wall protruding radially toward the outside from said longitudinal wall.

10. The pipe according to any one of the preceding claims, wherein said enclosure is made from impregnated composite fabric.

11. An aircraft comprising a fuselage defining an inner space, comprising a pipe according to any one of the preceding claims, at least partially arranged inside said fuselage, the annular space of said pipe being fluidly connected to the outside of said fuselage.

12. A method for installing a fluid transport pipe according to any one of claims 1 to 10, comprising:
supplying said fluid circulation hose,
installing said centering means around said hose; and
installing said outer protective tube around said centering means,
wherein the step for installing said outer protective tube around said centering means comprises a step for installing said shell around said hose and a step for winding said enclosure over the outer surface of said shell.
